(19) United States
(12) Patent Application Publication
(10) Pub. No.: US 2021/0082125 A1
(43) Pub. Date: Mar. 18, 2021

(54) CLIENT DEVICES HAVING MEDIA MANIPULATION FUNCTIONALITIES AND RELATED METHODS

(71) Applicant: POPSOCKETS LLC, Boulder, CO (US)

(72) Inventors: Altan NAHUM, Boulder, CO (US); Michael O'Brien, Albany, CA (US); Ayeisha Mesinger, Boulder, CO (US)

(73) Assignee: POPSOCKETS LLC, Boulder, CO (US)

(21) Appl. No.: 17/023,112

(22) Filed: Sep. 16, 2020

Related U.S. Application Data
(60) Provisional application No. 62/901,029, filed on Sep. 16, 2019.

(51) Int. Cl. G06T 7/194; G06T 3/00; G06T 7/11; G06F 3/0346; G06F 3/01

(52) U.S. Cl. CPC G06T 7/194; G06T 3/0056; G06F 3/017; G06F 3/0346; G06T 7/11

(57) ABSTRACT

Portable computing devices, software operating on and stored in such devices, and methods are described that utilize an image segmentation process for subsequent image alteration. Components of the computing device can sense or measure an input to apply a visual effect to masked and/or unmasked portions of an image or portions of a second image corresponding to the masked or unmasked portions of the image.

### TECHNICAL FIELD

The present disclosure generally relates to software applications on a portable client device that implement a sensor to receive user inputs.

### BACKGROUND

Many portable devices (e.g., tablets, smart phones) are equipped with an accelerometer that can detect an angular velocity and/or changes to the angular velocity of the device. The accelerometer may be implemented in a variety of applications including orienting the device during GPS navigation, adjusting the screen display based on the orientation of the device, and manipulating controls in games (e.g., steering a car in a racing game)

### SUMMARY

In accordance with a first aspect, a computer-implemented method for altering an image with a client device is described that includes running a segmentation algorithm on an image with a processing device of the client device to create masked and unmasked portions of the image, sensing or measuring an action with one or more components of the client device, creating a transformed image portion corresponding to at least one of the masked or unmasked portions of the image in response to sensing or measuring the action, where the transformed image portion has a visual effect applied thereto, and displaying a modified image with the transformed image portion over the at least one of the masked or unmasked portions of the image.

According to some forms, the computer-implemented method can include one or more of the following aspects: creating the transformed image portion can include applying the visual effect to the at least one of the masked or unmasked portions of the image; creating the transformed image portion can include applying the visual effect to a portion of a second image having an area corresponding to the at least one of the masked or unmasked portions of the image; creating the transformed image portion can include creating a transformed image portion corresponding to the masked portion of the image; the masked portion of the image can include a background of the image; the visual effect can include a kaleidoscope effect, a swirl effect, a light tunnel effect, a pixel sort effect, a pixel displacement effect, or a spatial region extent alteration effect; sensing or measuring the action with the one or more components of the client device can include sensing or measuring an action with one or more of a user input, microphone, camera, accelerometer, or gyroscope of the client device; or the method can include creating a motion clip of the creation of the transformed image portion over the at least one of the masked or unmasked portions of the image.

According to one form, creating the transformed image portion can include applying a pixel displacement effect; and the method can further include determining parameters for the pixel displacement effect based on the one or more gestures. In a further form, the method can include automating the parameters for the pixel displacement effect to create a motion clip of the creation of the transformed image portion.

In accordance with a second aspect, a non-transitory computer readable medium is disclosed herein that has instructions stored thereon that, in response to execution by a computing device, causes the computing device to perform operations that can include any one of the above methods.

In accordance with a third aspect, a client device having a processing device and a memory having executable instructions stored thereon is disclosed herein, where the processing device is configured to execute the instructions to perform any one of the above methods.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example computing environment in which the techniques of this disclosure can be implemented in accordance with various embodiments;

FIG. 2 is a block diagram of example client device with input components in accordance with various embodiments;

FIG. 3 is a diagrammatic view of a client device displaying an image segmented into masked and unmasked portion in accordance with various embodiments;

FIG. 4 is a diagrammatic view of a client device displaying a modified image having the masked portion of FIG. 3 as a transformed image portion displayed over the masked portion;

FIG. 5 is a diagrammatic view of a client device displaying a second image having an outline defining a region corresponding to the masked portion of FIG. 3 displayed thereon;

FIG. 6 is a diagrammatic view of a client device displaying a modified image having the region of FIG. 5 as a transformed image portion displayed over the masked portion of FIG. 3;

FIG. 7 is a flow chart for altering an image in accordance with various embodiments;

FIG. 8 is a schematic perspective view of a client device affixed with an expandable/collapsible grip accessory in accordance with various embodiments; and

FIG. 9 shows a diagram of a system including a device that supports action detection, and other aspects of the present disclosure.

### DETAILED DESCRIPTION

Portable computing devices, software operating on and stored in such devices, and methods are described herein that utilize an image segmentation process for subsequent image alteration. Further, input sensor data can be utilized to apply a visual effect to masked and/or unmasked portions of an image. When operating the software, a sensor within the device can sense or measure an action input from a user and, in response to sensing or measuring the action input, apply the visual effect to a selected region of the image. As such, a user can take a picture or otherwise select an image in an application operating on a client device, the software segments the subject of the image from the background, for example, and then the software allows the user to manipulate the background with gestures or other sensed or measured actions to be creative.

The image segmentation process partitions an image into multiple segments of pixels with the goal of clustering pixels into salient image regions. As such, the image segmentation process can be utilized to identify objects, boundaries, and background in the image. The devices, software, and methods described herein allow a user to alter the image regions based on an input to the device. For example, the image segmentation process can identify regions, such as people, animals, other subject objects, and background, including sky, trees, buildings, scenery, etc., and creates masked and unmasked regions of the image based on the image regions. A user can then create a transformed image portion that includes a visual effect, where the transformed image portion corresponds to at least one of the masked or unmasked portions of the image. For example, the visual effect can be applied to the masked and/or unmasked portions of the image or portions of a second image corresponding to the masked and/or unmasked portions. The visual effect can be applied based on user inputs to one or more sensors of the device.

The software described herein is particularly suitable for being implemented on a device affixed with a rotating accessory to enable users to easily rotate the device for input and media manipulation functionalities.

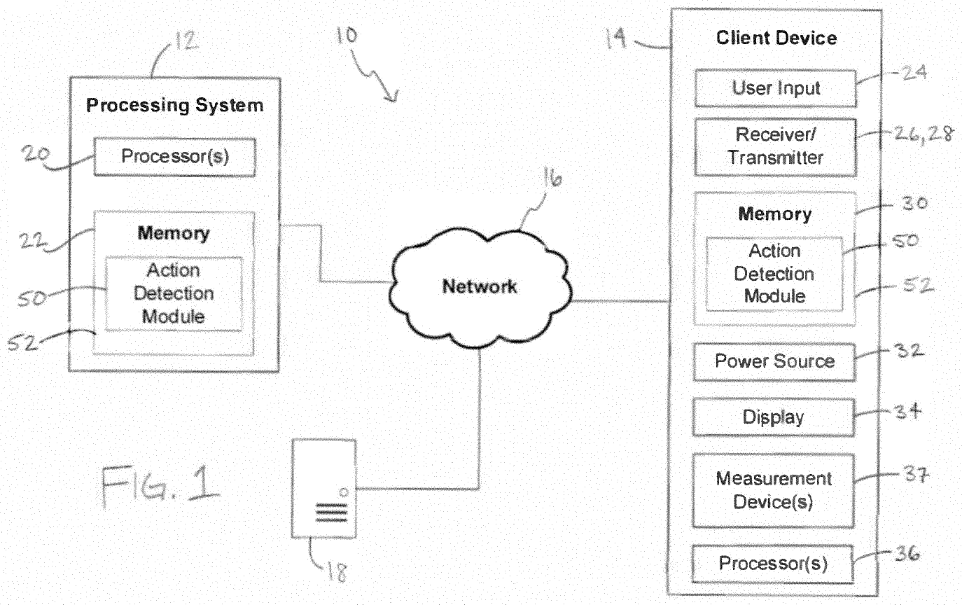

FIG. 1 illustrates one exemplary computing environment 10 in which techniques for sending and receiving media files may be implemented. In the computing environment 10, a processing system 12 can communicate with various client devices 14, application servers, web servers, and other devices via a communication network 16, which can be any suitable network, such as the Internet, WiFi, radio, Bluetooth, NFC, etc. The processing system 12 includes one or more servers or other suitable computing devices. The communication network 16 can be a wide-area network (WAN), a local-area network (LAN), virtual private networks (VPN), wireless networks (using 802.11, for example), cellular networks (using 3G, LTE, or 5G, for example), etc. In some configurations, the network 106 may include the Internet. The communications network 16 may include wired and/or wireless communication links. A third-party server 18 can be any suitable computing device that provides web content, applications, storage, etc. to various client devices 14. The content can include media, such as music, video, images, and so forth in any suitable file format. The methods and algorithms described herein can be implemented between multiple client devices 14, using the processing system 12 and/or the third party server 18 as an intermediary, storage device, and/or processing location.

In some examples, the processing system 12 may communicate with a server, which may be coupled to a database. The database may be internal or external to the server. In one example, processing system and/or devices 14 may be coupled to a database directly. In some examples, the database may be internally or externally connected directly to processing system 12 and/or devices 14. Additionally or alternatively, the database may be internally or externally connected directly to processing system 12 and/or devices or one or more network devices such as a gateway, switch, router, intrusion detection system, etc. The database may include action detection module 50 or operate portions of action detection module 50. In some examples, processing system 12 and/or devices 14 may access or operate aspects of action detection module 50 from the database over network 16 via, for example, the server. The database may include script code, hypertext markup language code, procedural computer programming code, compiled computer program code, object code, uncompiled computer program code, object-oriented program code, class-based programming code, cascading style sheets code, or any combination thereof.

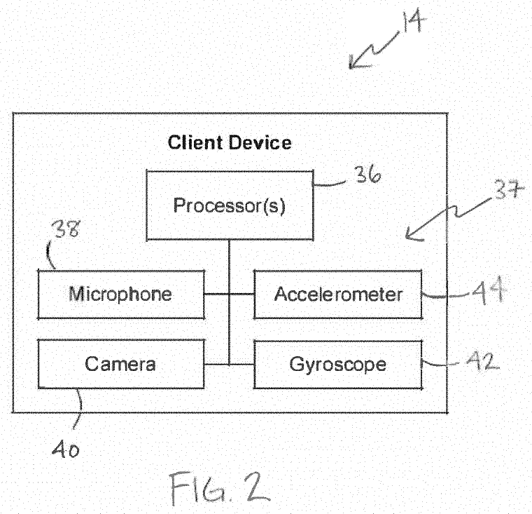

As illustrated in FIGS. 1 and 2, the processing system 12 can include one or more processing devices 20 and a memory 22. The memory 22 can include persistent and non-persistent components in any suitable configuration. If desired, these components can be distributed among multiple network nodes. The client device 14 can be any suitable portable computing devices, such as a mobile phone, tablet, E-reader, and so forth. The client device 14 can be configured as commonly understood to include a user input 24, such as a touch screen, keypad, switch device, voice command software, or the like, a receiver 26, a transmitter 28, a memory 30, a power source 32, which can be replaceable or rechargeable as desired, a display 34, and a processing device 36 controlling the operation thereof. As shown in FIG. 2, the client device 14, in addition to the user input 24, also includes components 37 that can measure, sense, or receive actions or inputs from a user. For example, the client device 14 can include a microphone 38, a camera device 40, a gyroscope 42, and an accelerometer 44. As commonly understood, the components 37 of the device 14, as well as other electrical components, are connected by electrical pathways, such as wires, traces, circuit boards, and the like. The memory 30 can include persistent and non-persistent components.

The term processing devices, as utilized herein, refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processing devices disclosed herein may be configured (for example, by using corresponding programming stored in a memory as will be well understood by those skilled in the art) to carry out one or more of the steps, actions, and/or functions described herein.

The components 37 of the client device 14 can advantageously be utilized to input alteration actions to manipulate an image as described herein. For example, the user input device 24 can sense particular gestures input by the user, such as dragging one or more fingers across the screen, swirling a finger on the screen, inputting zoom in or zoom out gestures on the screen, and so forth; the microphone 38 can be utilized by a user to input a command to the client device 14, while the camera device 40 can be utilized by a user to capture a particular gesture or series of gestures. Additionally, the client device 14 can operate image analysis software, either stored locally or operated remotely, to analyze the image, series of images, and/or video to detect a predetermined gesture, object, or activity. For example, the image analysis software can be configured to detect an action, such as waving, clapping, twisting, slapping, or other hand and/or arm gestures, making funny faces with particular facial distortions, and so forth. The gyroscope 42 can measure an orientation and angular velocity of the client device 14. The accelerometer 44 can measure a general rotation, an angular velocity, a rate of change, a direction of orientation and movement, and/or determine an orientation of the device 14 in a three-dimensional space. In addition or an alternative to the above image analysis software, the gyroscope 42 and/or accelerometer 44 can provide measurements to the processing device 36 indicative of a particular action being done by a user or with the client device 14, such as spinning, shaking, waving, clapping, and so forth.

Referring back to FIG. 1, the client device 14 can include an action detection module 50 stored in the memory 30 as a set of instructions executable by the processing device 36. The action detection module 50 is configured to analyze measurements from or inputs to one or more of the components 24, 38, 40, 42, 44 of the device 14 to identify predetermined alteration events or control the application of a selected alteration event as set forth below. If desired, the functionality of the action detection module 50 also can be implemented as an action detection module application programming interface (API) 52 stored in the memory 30 that can include any content that may be suitable for the techniques of the current disclosure, which various applications executing on servers and/or client devices can invoke. For example, the API 52 may perform a corresponding action to alter an image on the client device 14 in response to a detected alteration event of the client device 14 detected by the action detection module 50. The action detection module 50, as set forth below, can invoke the API 52 when necessary, without having to send data to the processing system 12. In other versions, one or more steps of the below-described methods/algorithms can have cloud-based processing and/or storage and the processing system 12 can include an action detection module 50, configured as described with the above form, stored in the memory 30 as a set of instructions executable by the processing device 36.

The image being altered according to a given alteration event can be stored locally or provided by the third party server 18. The image can further be captured using the camera device 40 through the API 52 or selected from pre-saved images/videos. The image can be a photograph, illustration, etc.

An example client device 14 having graphical user interfaces (GUIs) with example display actions provided by application software operating on the client 14 is shown in FIGS. 3-6. The software can provide a GUI 100 displaying a selected image 102 having masked regions 104 and unmasked regions 106 of the image 102 identified. In one example, the masked regions 104 can correspond to background of the image 102, while the unmasked regions 106 can correspond to a subject of the image, such as a person, animal, or other object. The regions 104, 106 can be identified on the GUI 100 by any suitable mechanism, such as by outlines, shading, a patterned fill, and so forth. A user can then select one or more of the regions 104, 106 of the image 102 for alteration with the user input 24.

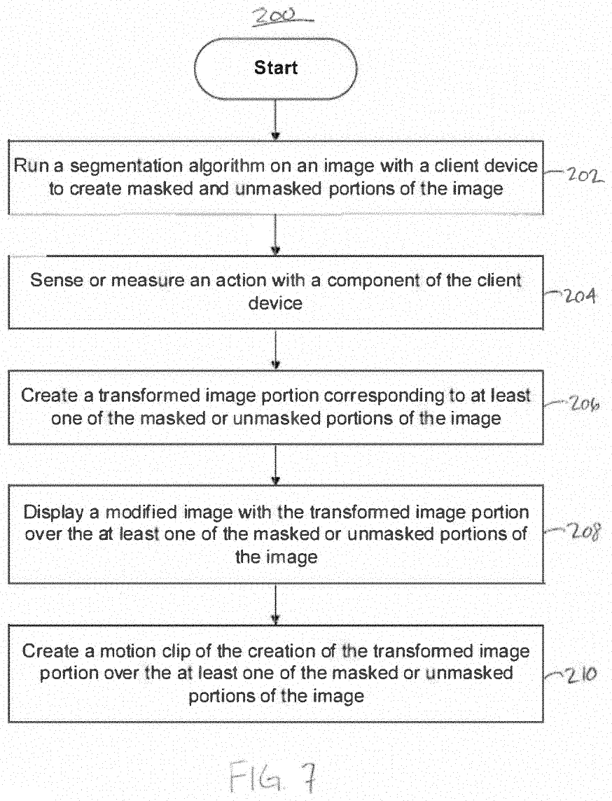

Optionally, as shown in FIG. 5, the user can also select or input a second image 108 to provide a region or regions 110 corresponding to the selected one or more regions 104, 106. After receiving the selection or input of the second image 108, the application software can superimpose an outline or border 112 of the one or more regions 110 over the second image 108 to show a user the image region 110 that could be pasted over the image 102. The outline or border 112 can be movable via manipulation of the user input 24 to allow a user to select a desired portion of the second image 108 for the region 110.

Thereafter, a user can select a desired visual effect to apply to alter the selected regions 104, 106, 110. The selection of the desired visual effect can be achieved by selection of an icon 114 with the user input 24 corresponding to the visual effect 108 or performing an action corresponding to the visual effect, for example. In the latter configuration, the processing device 36 can determine an associate visual effect after determining a particular action detected by the action detection module 50. In some examples, the available visual effects can include a kaleidoscope effect, a swirl effect, a light tunnel effect, a pixel sort effect, a pixel displacement effect, or a spatial region extent alteration effect.

In some versions, after the desired visual effect is selected, a user can perform an action and the visual effect can be applied to the selected regions 104, 106, 110 by the API 42 upon detection by the action detection module 50 to create a transformed image portion 116. In some versions, the action can also effect an intensity, size, or frequency of the visual effect. In other versions, the user can perform a second action to effect the intensity, size, or frequency of the visual effect. In one example where the visual effect is a pixel displacement effect, the action or second action can be used as input for the processing device 36 to determine one or more corresponding parameters for the pixel displacement effect based on the action or actions.

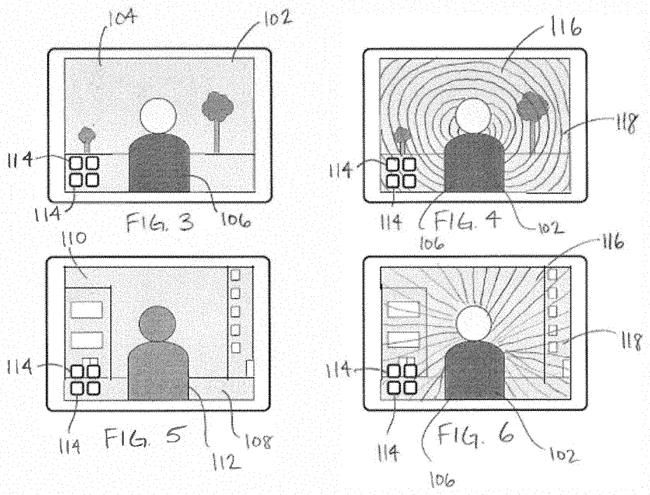

As shown in FIGS. 4 and 6, after the transformed image portion 116 is created to a user's satisfaction, the software can paste or superimpose the transformed image portion 116 over the selected regions 104, 106 of the image 102 to create a modified image 118 and display the modified image 118 on the device 14.

In some versions, the software can sequentially apply the selected visual effect to the selected region(s) 104, 160, 110 to create a motion clip of the transformation. In some forms, the software can create and save a video or gif file of the transformation. For example, if a user selected the pixel displacement effect, the application software can automate the parameters for the pixel displacement effect to create a motion clip of the creation of the transformed image portion 116

If desired, the GUI 100 can include display options for selection by the user using the user input 24, which can include inserting alphanumeric and/or graphical content, such as text, stickers, emoticons or other graphics, cropping, resizing, altering color/contrast characteristics, and so forth. The API 52 can take any tags and/or settings into account, as well as parameters that include any modifiers, filters, and/or effects selected or assigned for the GUI 100.

As discussed previously, the client device 14 can be used to send the modified image 118 and/or motion clip to a remote device, whether within the framework of the application software or through a separate messaging functionality of the client device 14.

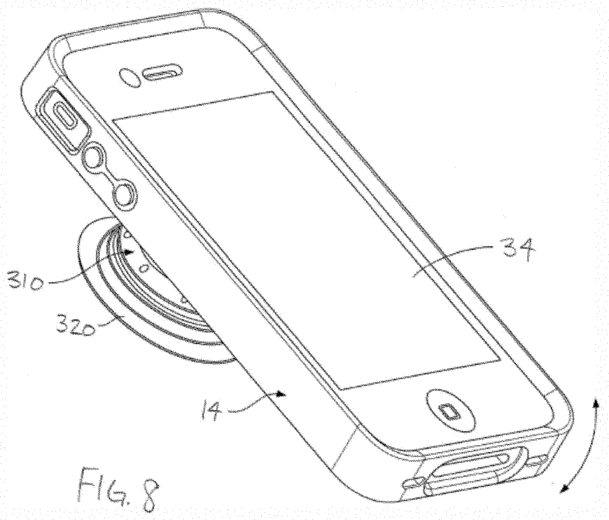

Referring now to a flowchart as shown in FIG. 7, a method and software algorithm 200 of modifying the image 102. In a first step 202, the method and algorithm 200 includes running a segmentation algorithm on an image 102 with a processing device 36 of the client device 14 to create masked and unmasked portions 104, 106 of the image 102. In a second step 204, an action is sensed or measured by a component 37 of the client device 14. In a third step 206, a transformed image portion 116 is created that corresponds to at least one of the masked or unmasked portions 104, 106 of the image 102 in response to sensing or measuring the action. The transformed image portion 116 has a visual effect applied thereto. In a further step 208, the method and software algorithm 200 includes displaying a modified image 118 with the transformed image portion 116 over the at least one of the masked or unmasked portions 104, 106 of the image 102. In an optional step 210, the method and software algorithm 200 can include creating a motion clip of the creation of the transformed image portion 116 over the at least one of the masked or unmasked portions 104, 106 of the image 102.

For many approaches, the functionalities described herein can be utilized by a user twisting or otherwise manipulating the client device 14 in a hand, spinning or moving the client device 14 on a surface, and so forth. To further enable a user to easily rotate, spin, and manipulate the client device 14, the device 14 may be affixed with an expandable/collapsible grip accessory 310, as illustrated in FIG. 8.

FIG. 8 schematically illustrates a client device 14 affixed with a grip accessory 310. The grip accessory 310 may include a rotating portion 320, which can include bearings, low-friction couplings, etc., that allows the client device 14 to spin freely relative to the remainder of the grip accessory 310, when the grip accessory 310 is held in a user's hand or placed on a surface, for example. In some instances, the grip accessory 310 of the current disclosure may include, at least in part, an extending grip accessory for a portable media player or portable media player case as disclosed in U.S. Pat. No. 8,560,031, or U.S. Publication No. 2018/0288204, entitled “Spinning Accessory for a Mobile Electronic Device,” the entire disclosures of which are incorporated herein in their entireties by this reference.

The application software described herein can be available for purchase and/or download from any website, online store, or vendor over the communication network 16. Alternatively, a user can download the application onto a personal computer and transfer the application to the client device 14. When operation is desired, the user runs the application on the client device 14 by a suitable selection through the user input 24.

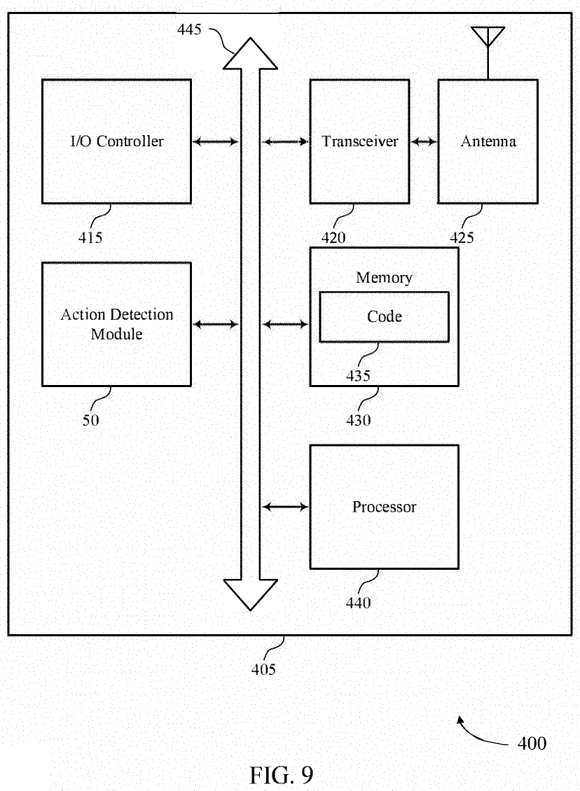

FIG. 9 shows a diagram of a system 400 including a device 402 that supports discovering, accessing and/or displaying a menu associated with a venue in accordance with aspects of the present disclosure. The device 402 may be an example of or include the components of processing system 12 or client device 14 show in FIG. 1, or any other system or device as described herein. The device 402 may include components for bi-directional voice and data communications including components for transmitting and receiving communications, including an action detection module 50, an I/O controller 404 a transceiver 406 an antenna 408 memory 410 a processor 414 and a coding manager 450 These components may be in electronic communication via one or more buses (e.g., bus 416.

The action detection module 50 may provide any combination of the operations and functions described above related to FIGS. 1-8

The I/O controller 404 may manage input and output signals for the device 402 The I/O controller 404 may also manage peripherals not integrated into the device 402 In some cases, the I/O controller 404 may represent a physical connection or port to an external peripheral. In some cases, the I/O controller 404 may utilize an operating system such as iOS®, ANDROID®, MS-DOS®, MS-WINDOWS®, OS/2®, UNIX®, LINUX®, or another known operating system. In other cases, the I/O controller 404 may represent or interact with a modem, a keyboard, a mouse, a touchscreen, or a similar device. In some cases, the I/O controller 404 may be implemented as part of a processor. In some cases, a user may interact with the device 402 via the I/O controller 404 or via hardware components controlled by the I/O controller 404

The transceiver 406 may communicate bi-directionally, via one or more antennas, wired, or wireless links as described herein. For example, the transceiver 406 may represent a wireless transceiver and may communicate bi-directionally with another wireless transceiver. The transceiver 406 may also include a modem to modulate the packets and provide the modulated packets to the antennas for transmission, and to demodulate packets received from the antennas.

In some cases, the wireless device may include a single antenna 408 However, in some cases the device may have more than one antenna 408, which may be capable of concurrently transmitting or receiving multiple wireless transmissions.

The memory 410 may include RAM and ROM. The memory 410 may store computer-readable, computer-executable code 412 including instructions that, when executed, cause the processor to perform various functions described herein. In some cases, the memory 410 may contain, among other things, a BIOS which may control basic hardware or software operation such as the interaction with peripheral components or devices.

The processor 414 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 414 may be configured to operate a memory array using a memory controller. In other cases, a memory controller may be integrated into the processor 414. The processor 414 may be configured to execute computer-readable instructions stored in a memory (e.g., the memory 410) to cause the device 402 to perform various functions (e.g., functions or tasks supporting menu related functions and other functions associated with the systems and methods disclosed herein).

The code 412 may include instructions to implement aspects of the present disclosure, including instructions to support dynamic accessibility compliance of a website. The code 412 may be stored in a non-transitory computer-readable medium such as system memory or other type of memory. In some cases, the code 412 may not be directly executable by the processor 414 but may cause a computer (e.g., when compiled and executed) to perform functions described herein.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, computer environment 10, system 12 and/or device 14 of FIGS. 1-8.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical venues. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method for altering an image with a client device, the method comprising:
running a segmentation algorithm on an image with a processing device of the client device to create masked and unmasked portions of the image;
sensing or measuring an action with one or more components of the client device;
creating a transformed image portion corresponding to at least one of the masked or unmasked portions of the image in response to sensing or measuring the action, the transformed image portion having a visual effect applied thereto; and
displaying a modified image with the transformed image portion over the at least one of the masked or unmasked portions of the image.

2. The computer-implemented method of claim 1, wherein creating the transformed image portion comprises applying the visual effect to the at least one of the masked or unmasked portions of the image.

3. The computer-implemented method of claim 1, wherein creating the transformed image portion comprises applying the visual effect to a portion of a second image having an area corresponding to the at least one of the masked or unmasked portions of the image.

4. The computer-implemented method of claim 1, wherein creating the transformed image portion comprises creating a transformed image portion corresponding to the masked portion of the image.

5. The computer-implemented method of claim 1, wherein the masked portion of the image comprises a background of the image.

6. The computer-implemented method of claim 1, wherein the visual effect comprises a kaleidoscope effect, a swirl effect, a light tunnel effect, a pixel sort effect, a pixel displacement effect, or a spatial region extents alteration effect.

7. The computer-implemented method of claim 1, wherein sensing or measuring the action with the one or more components of the client device comprises sensing or measuring an action with one or more of a user input, microphone, camera, accelerometer, or gyroscope of the client device.

8. The computer-implemented method of claim 7, wherein sensing or measuring the action with the one or more components of the client device comprises sensing or measuring one or more gestures with at least one of a user input or a camera of the client device.

9. The computer-implemented method of claim 1, wherein creating the transformed image portion comprises applying a pixel displacement effect; and further comprising determining parameters for the pixel displacement effect based on the one or more gestures.

10. The computer-implemented method of claim 9, further comprising automating the parameters for the pixel displacement effect to create a motion clip of the creation of the transformed image portion.

11. The computer-implemented method of claim 1, further comprising creating a motion clip of the creation of the transformed image portion over the at least one of the masked or unmasked portions of the image.

12. A non-transitory computer-readable medium having instructions stored thereon that, in response to execution by a computing device, cause the computing device to perform operations, the operations comprising:
running a segmentation algorithm on an image with a processing device of the client device to create masked and unmasked portions of the image;
sensing or measuring an action with one or more components of the client device;
creating a transformed image portion corresponding to at least one of the masked or unmasked portions of the image in response to sensing or measuring the action, the transformed image portion having a visual effect applied thereto; and
displaying a modified image with the transformed image portion over the at least one of the masked or unmasked portions of the image.

13. The non-transitory computer readable medium of claim 12, wherein creating the transformed image portion comprises applying the visual effect to the at least one of the masked or unmasked portions of the image.

14. The non-transitory computer readable medium of claim 12, wherein creating the transformed image portion comprises applying the visual effect to a portion of a second image having an area corresponding to the at least one of the masked or unmasked portions of the image.

15. The non-transitory computer readable medium of claim 12, wherein creating the transformed image portion comprises creating a transformed image portion corresponding to the masked portion of the image.

16. The non-transitory computer readable medium of claim 12, wherein the masked portion of the image comprises a background of the image.

17. The non-transitory computer readable medium of claim 12, wherein the visual effect comprises a kaleidoscope effect, a swirl effect, a light tunnel effect, a pixel sort effect, a pixel displacement effect, or a spatial region extents alteration effect.

18. The non-transitory computer readable medium of claim 12, wherein sensing or measuring the action with the one or more components of the client device comprises sensing or measuring an action with one or more of a user input, microphone, camera, accelerometer, or gyroscope of the client device.

19. The non-transitory computer readable medium of claim 18, wherein sensing or measuring the action with the one or more components of the client device comprises sensing or measuring one or more gestures with at least one of a user input or a camera of the client device.

20. A client device, comprising:
a processing device;
a memory having executable instructions stored thereon, the processing device being configured to execute the instructions to:
run a segmentation algorithm on an image with a processing device of the client device to create masked and unmasked portions of the image;
sense or measuring an action with one or more components of the client device;
create a transformed image portion corresponding to at least one of the masked or unmasked portions of the image in response to sensing or measuring the action, the transformed image portion having a visual effect applied thereto; and
display a modified image with the transformed image portion over the at least one of the masked or unmasked portions of the image
